(19) United States
(12) Patent Application Publication
(10) Pub. No.: US 2008/0042391 A1
(43) Pub. Date: Feb. 21, 2008

(54) INDEPENDENT SUSPENSION SYSTEM

(76) Inventors: John Holland, County Meath (IE); Tomas McCabe, County Louth (IE)

Correspondence Address: HOLLAND & KNIGHT LLP, 10 ST. JAMES AVENUE, 11th Floor, BOSTON, MA, 02116-3889, US

(21) Appl. No.: 11/697,521

(22) Filed: Apr. 6, 2007

(30) Foreign Application Priority Data
Apr. 7, 2006 (IE) S2006/0267

(51) Int. Cl. B60G 9/00; B60G 11/00; B60G 7/00

(52) U.S. Cl. 280/124.134; 280/124.1

(57) ABSTRACT

An independent suspension system for mounting on a vehicle chassis which includes a pair of spaced-apart longitudinal chassis rails has a U-shaped support frame for attachment to the vehicle chassis rails. The support frame has a pair of side frame members, upper ends of which are adapted for engagement with the chassis rails. Lower ends of the side frame members are interconnected by a pair of spaced-apart cross members which are demountably secured between the side frame members. Each cross member has an elongate tubular body with flanged ends having through holes for reception of mounting bolts to secure the cross member to the side frame members.

### RELATED APPLICATIONS

This application claims the priority of the following application, which is herein incorporated by reference: Irish Application No.: S2006/0267; filed 7 Apr. 2006, entitled: “Independent Suspension System”.

### TECHNICAL FIELD

This invention relates to an independent suspension system.

### BACKGROUND

The invention is particularly concerned with independent front suspension systems for heavy road vehicles.

The present invention is directed towards providing an improved independent suspension system for such vehicles.

### SUMMARY OF DISCLOSURE

According to the invention there is provided an independent suspension system for mounting on a vehicle chassis which includes a pair of spaced-apart longitudinal chassis rails, the suspension system including:
a U-shaped support frame for attachment to the vehicle chassis rails;
said support frame having a pair of spaced-apart side frame members, each having an upper end and a lower end;
an upper end of each side frame member being adapted for engagement with and attachment to a chassis rail of the vehicle;
the lower ends of the side frame members being interconnected by at least one cross member which extends therebetween;
said cross member being demountably secured to each side frame member;
an independent wheel suspension assembly being mounted on each side frame member.

In a preferred embodiment, a pair of spaced-apart cross members are demountably secured between the side frame members. These are preferably located at a front end and at a rear end of the side frame members.

In another embodiment each cross member is bolted to each of the side frame members. Thus advantageously each cross member may be removed if required for access to, for example, an engine located within the mounting frame for maintenance and the like.

In another embodiment, each cross member has an elongate tubular body with flanged ends having through holes for reception of mounting bolts.

In another embodiment, each cross member has an elongated flange portion above the body extending upwardly therefrom.

In a further embodiment, each flange nests in an associated well at a lower end of the side frame member to which it is attached.

In a preferred embodiment each cross member comprises a high strength austempered ductile iron (ADI) casting.

In another embodiment each cross member has an elongate body with flanged ends having through-holes for reception of mounting bolts.

In a further embodiment each wheel suspension assembly comprises an upper control arm and an associated lower control arm, said control arms having inner ends pivotally mounted on the side frame member and outer ends pivotally attached to a wheel hub. A spring and damper assembly is mounted between one of the control arms, preferably the lower control arm, and the side frame member.

In another embodiment an outer end of each control arm is attached by a ball joint to the wheel hub.

In another embodiment, the ball joints have kingpins which are inclined to the vertical. The kingpins may be inclined at an angle in the range of 7° to 12° and preferably are inclined at an angle of about 10°.

In another embodiment, the kingpins of the ball joints are located on the wheel hub to provide a positive caster off-set. The positive caster off-set may be up to 40 mm and is preferably about 30 mm.

In another aspect the invention provides a U-shaped support frame for a suspension system, the support frame having a pair of spaced-apart side frame members each having an upper end and a lower end, an upper end of each side frame member being adapted for engagement with an attachment to a vehicle chassis, the lower ends of the side frame members being interconnected by at least one cross member which extends therebetween, said cross member being demountably secured to each side frame member, and means for mounting a wheel suspension assembly on each side frame member.

### BRIEF DESCRIPTION OF THE DRAWINGS

The invention will be more clearly understood by the following description of some embodiments thereof, given by way of example only, with reference to the accompanying drawings, in which:

FIG. 1 is a plan view of an independent suspension system of the invention;

FIG. 2 is an elevational view of the independent suspension system;

FIG. 3 is a perspective view of the independent suspension system;

FIG. 4 is an end view of the independent suspension system;

FIG. 5 is a perspective view of a demountable cross member of the system;

FIG. 6 is an end elevational view of the cross member;

FIG. 7 is a sectional elevational view of the cross member taken along the line VII to VII of FIG. 6;

FIG. 8 is a sectional view along the lines VIII-VIII of FIG. 7;

FIG. 9 is a detail perspective view showing portion of an independent wheel suspension assembly of the system;

FIG. 10 is an elevational view of portion of the independent wheel suspension assembly; and

FIG. 11 is an end elevational view of portion of the independent wheel suspension assembly.

### DETAILED DESCRIPTION OF THE PREFERRED EMBODIMENTS

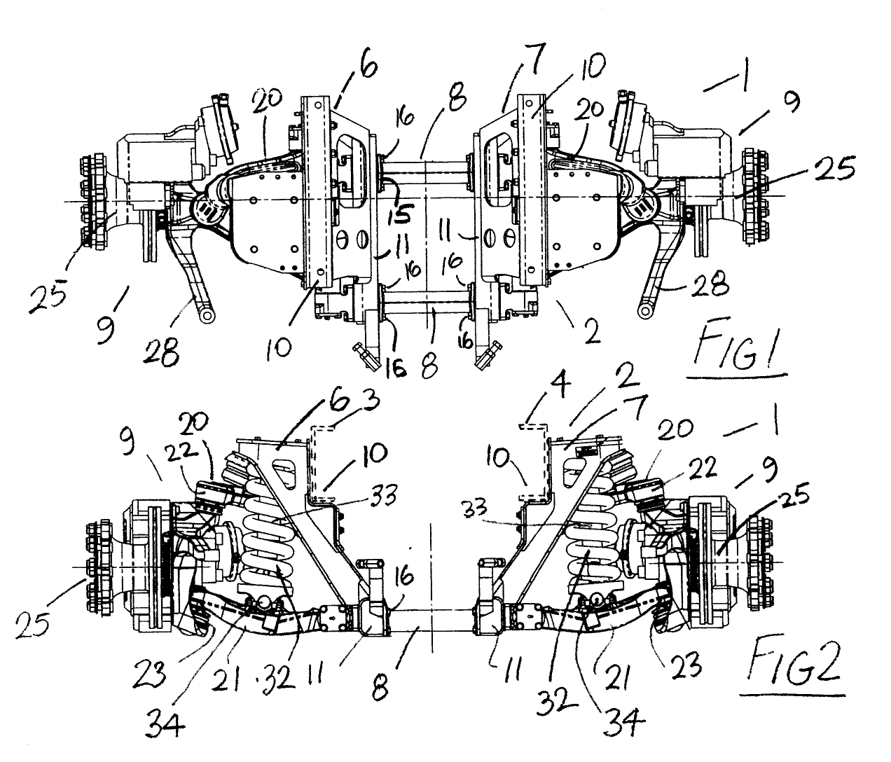

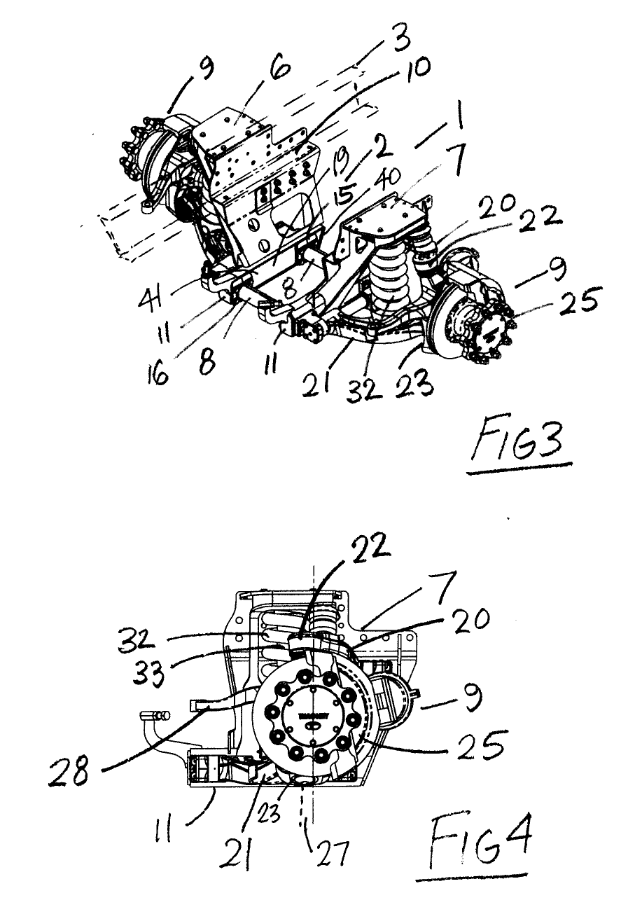

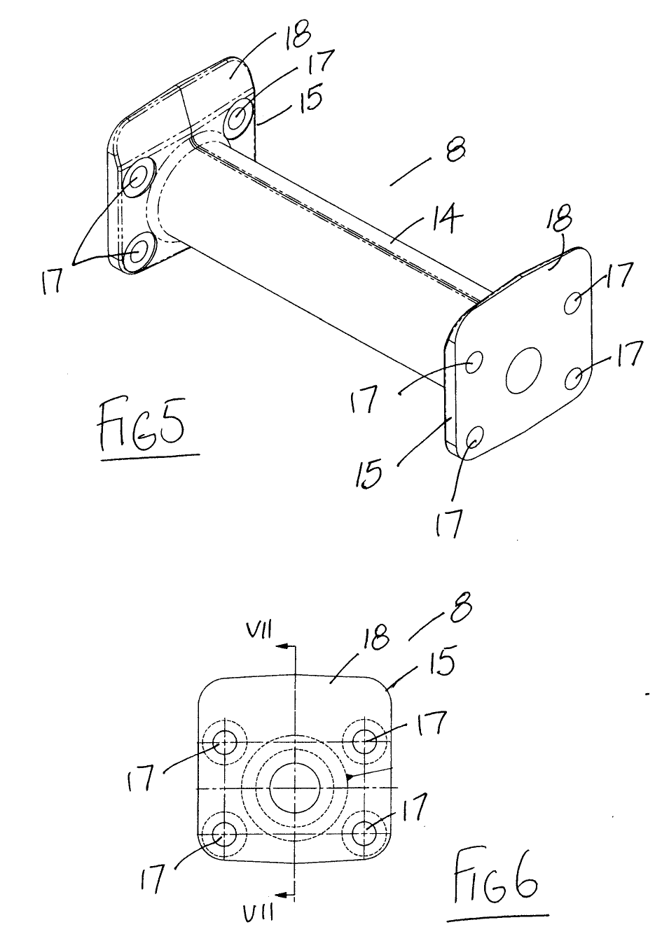

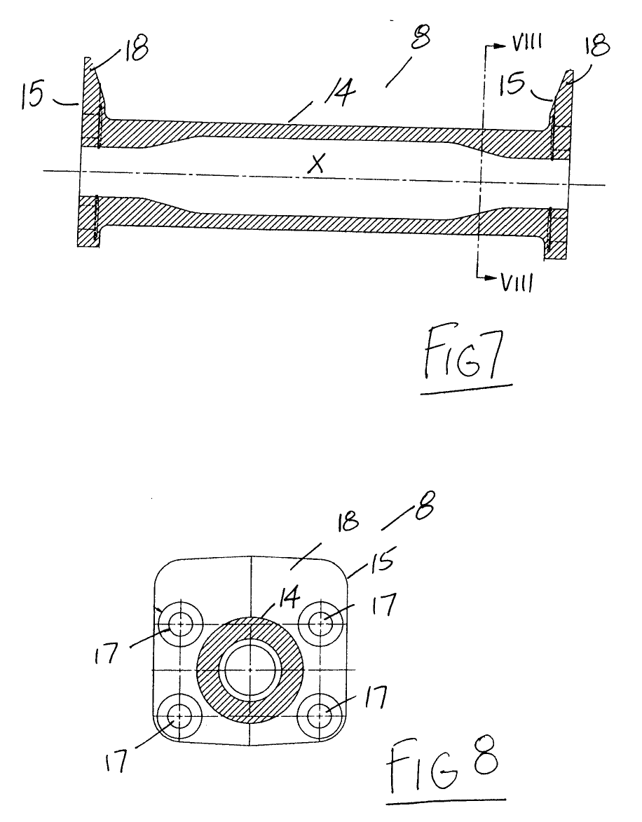

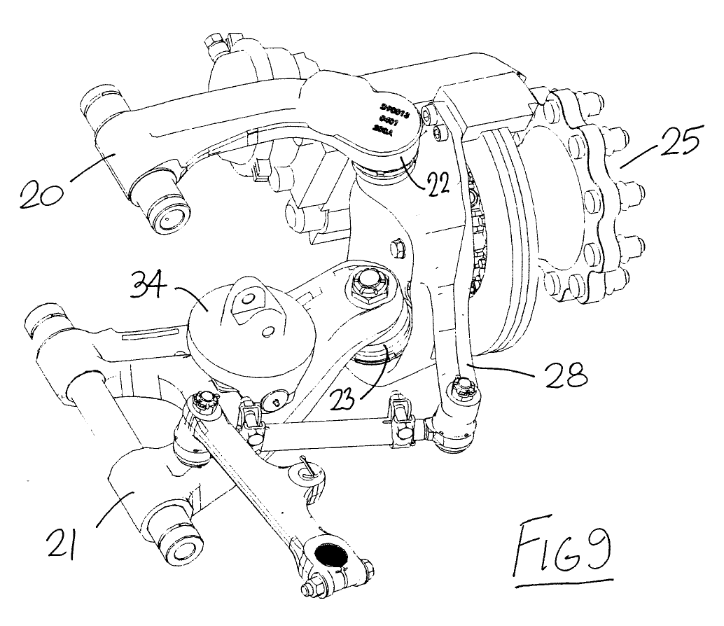

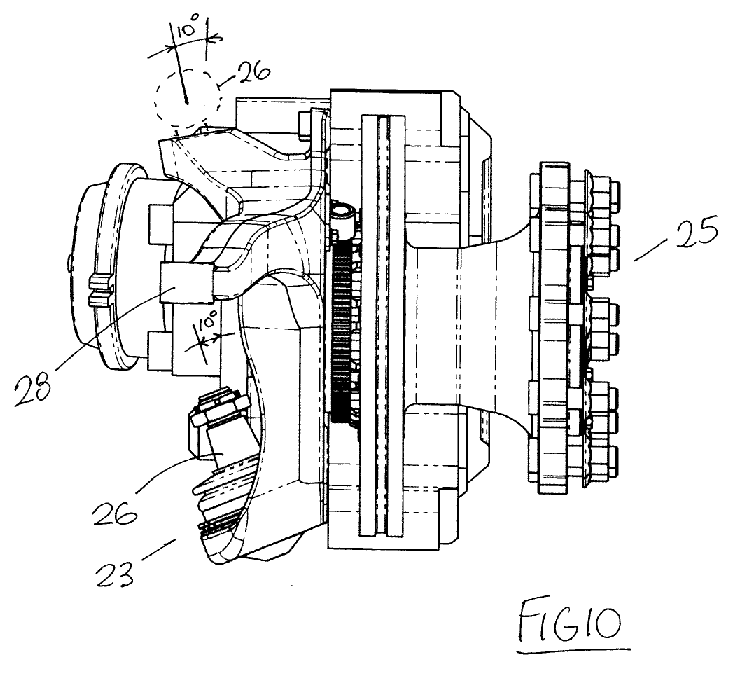

Referring to the drawings, there is illustrated a modular independent suspension system according to the invention indicated generally by the reference numeral 1. The system 1 has a U-shaped support frame indicated generally by the reference numeral 2 for attachment to a pair of spaced-apart longitudinal chassis rails 3, 4 (shown in broken outline) on a vehicle, as shown in FIG. 2. The support frame 2 includes a pair of spaced-apart side frame members 6, 7 interconnected at their lower ends by a pair of demountable cross members 8. An independent wheel suspension assembly 9 is mounted on each side frame member 6, 7.

Each side frame member 6, 7 has a stepped upper end 10 for attachment to a chassis rail 3, 4 to which they are bolted as shown in FIG. 2. Lower ends 11 of the side frame members 6, 7 are interconnected by the pair of spaced-apart cross members 8. These cross members 8, as can be seen in FIG. 1 and FIG. 3, are positioned at a front end and at a rear end of the side frame members 6, 7 thus forming a rigid support frame 2.

Each cross member 8 comprises a high strength austempered ductile iron casting. The cross member 8 has an elongate tubular cylindrical body 14 with flanged ends 15. These flanges 15 are substantially perpendicular to a central axis X of the body 14 and have through-holes 17 for reception of mounting bolts 16 by means of which the cross members 8 are demountably secured to the lower ends 11 of the side members 6, 7. This conveniently allows removal of the cross members 8 if required for maintenance purposes. The length of the cross member can be changed to suit different chassis rail spacings.

It will be noted that the cylindrical body 14 is off-set towards a bottom of the flanges 15 leaving an elongated upper flange portion 18. This provides a greater contact area at the top where there are greater bending forces in use. It will also be seen from FIG. 3 that each flange 15 nests into a shallow well 19 formed at an inside face of each lower end 11 of the side frame member 6, 7. The well 19 is formed by an upstanding peripheral rim 40 which extends around at least portion of an inner side wall 41 of the lower end 11 to which the cross member 8 is attached.

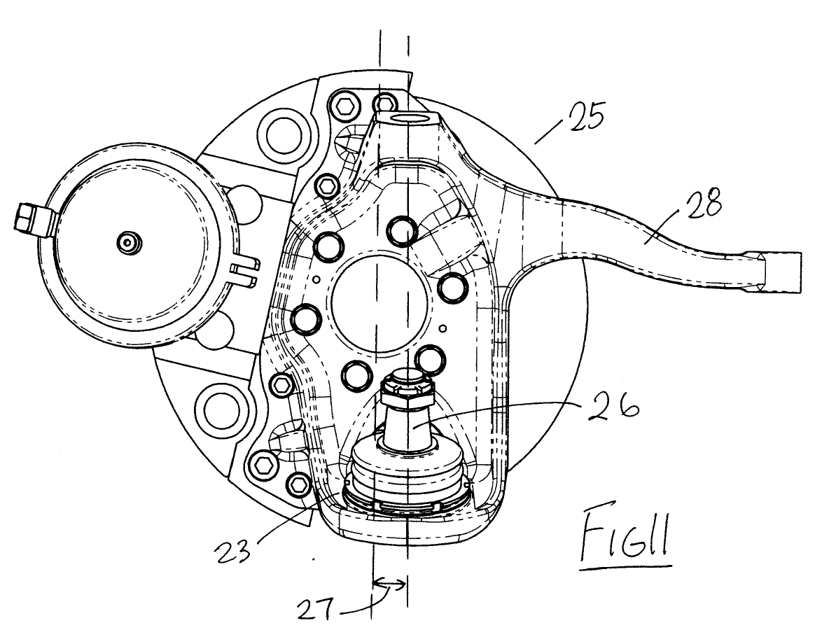

Each wheel suspension assembly 9 comprises an upper control arm 20 and an associated lower control arm 21. Inner ends of the control arms 20, 21 are pivotally mounted on the side frame member 6, 7 so that the control arms 20, 21 can pivot up and down on the side frame member 6, 7. An outer end of each control arm 20, 21 is pivotally mounted by a ball joint 22, 23 to a wheel hub 25. King pins 26 of the ball joints are inclined at 10° to the vertical as shown in FIG. 10. Also as can be seen in FIG. 11 and FIG. 4 a positive caster offset 27 of approximately 30 mm has been incorporated which aids the self-centering tendency of the design. An integrated steering arm 28 is provided on the wheel hub 25, being integrally cast with the inner knuckle casting part of the wheel hub 25 assembly.

A coil spring 32 with an associated damper 33 housed within the coil spring 32 is mounted between a pivot mount 34 on the lower control arm 21 and an upper end of the side member 6, 7. In alternative arrangements other spring means may be provided such as hydraulic struts or airbags for example.

The invention is not limited to the embodiments hereinbefore described which may be varied in both construction and detail within the scope of the appended claims.

What is claimed is:

1. An independent suspension system for mounting on a vehicle chassis which includes a pair of spaced-apart longitudinal chassis rails, the suspension system including:
a U-shaped support frame for attachment to the vehicle chassis rails;
said support frame having a pair of spaced-apart side frame members, each having an upper end and a lower end;
an upper end of each side frame member being adapted for engagement with and attachment to a chassis rail of the vehicle;
the lower ends of the side frame members being interconnected by a pair of spaced-apart cross members which extend therebetween;
each cross member being demountably secured to each side frame member;
an independent wheel suspension assembly being mounted on each side frame member.

2. The independent suspension system as claimed in claim 1 wherein each cross member has an elongate tubular body with flanged ends having through-holes for reception of mounting bolts.

3. The independent suspension system as claimed in claim 1 wherein the cross members are located at a front end and at a rear end of the side frame members.

4. The independent suspension system as claimed in claim 1 wherein each cross member is bolted to each of the side frame members.

5. The independent suspension system as claimed in claim 1 wherein each cross member comprises a high strength austempered ductile iron (ADI) casting.

6. The independent suspension system as claimed in claim 2 wherein each cross member has an elongated flange portion above the body extending upwardly therefrom.

7. The independent suspension system as claimed in claim 2 wherein each flange nests in an associated well at a lower end of the side frame member to which it is attached.

8. The independent suspension system as claimed in claim 1 wherein each wheel suspension assembly comprises an upper control arm and an associated lower control arm, said control arms having inner ends pivotally mounted on the side frame member and outer ends pivotally attached to a wheel hub.

9. The independent suspension system as claimed in claim 8 wherein an outer end of each control arm is connected by a ball joint to the wheel hub.

10. The independent suspension system as claimed in claim 9 wherein said ball joints have kingpins which are inclined to the vertical.

11. The independent suspension system as claimed in claim 10 wherein the kingpins are inclined to the vertical at an angle in the range of 7° to 12°.

12. The independent suspension system as claimed in claim 11 wherein the kingpins are inclined at an angle of about 10° to the vertical.

13. The independent suspension system as claimed in claim 9 wherein kingpins of the ball joints are located on the wheel hub to provide a positive caster off-set.

14. The independent suspension system as claimed in claim 13 wherein the positive caster off-set is up to 40 mm.

15. The independent suspension system as claimed in claim 14 wherein the positive caster off-set is about 30 mm.

16. An independent suspension system for mounting on a vehicle chassis which includes a pair of spaced-apart longitudinal chassis rails, the suspension system including:
a U-shaped support frame for attachment to the vehicle chassis rails;
said support frame having a pair of spaced-apart side frame members, each having an upper end and a lower end;
an upper end of each side frame member being adapted for engagement with and attachment to a chassis rail of the vehicle;
the lower ends of the side frame members being interconnected by a pair of spaced-apart cross members which extend there between;
each cross member being demountably secured to each side frame member;
an independent wheel suspension assembly being mounted on each side frame member;
the cross members being located at a front end and at a rear end of the side frame members;
each cross member having an elongate tubular body with flanged ends having through-holes for reception of mounting bolts;
each cross member being bolted to each of the side frame members;
each cross member comprising a high strength austempered ductile iron casting.

17. A U-shaped support frame for mounting on a vehicle chassis having a pair of spaced-apart longitudinal chassis rails, the support frame including:
a pair of spaced-apart side frame members, each having an upper end and a lower end,
an upper end of each side frame member being adapted for engagement with and attachment to a vehicle chassis,
the lower ends of the side frame members being interconnected by a pair of spaced-apart cross members which extended there between,
each cross member being demountably secured to each side frame member,
means for mounting a wheel suspension assembly on each side frame member.

18. The support frame as claimed in claim 17 wherein each cross member has an elongated tubular body with flanged ends having through holes for reception of mounting bolts for securing each cross member to the side frame members, each cross member comprising a high strength austempered ductile iron casting.
